(19) United States
(12) Patent Application Publication
(10) Pub. No.: US 2026/0019265 A1
(43) Pub. Date: Jan. 15, 2026

(54) SYSTEMS, METHODS, AND PROTOCOLS FOR ZERO KNOWLEDGE PROOF USER AUTHENTICATION

(71) Applicant: T Stamp Inc., Atlanta, GA (US)

(72) Inventors: Norman Hoon Thian Poh, Atlanta, GA (US); Daryl Burns, Atlanta, GA (US)

(21) Appl. No.: 19/268,664

(22) Filed: Jul. 14, 2025

Related U.S. Application Data
(60) Provisional application No. 63/670,476, filed on Jul. 12, 2024.

(51) Int. Cl. H04L 9/32; H04L 9/08

(52) U.S. Cl. CPC H04L 9/3221; H04L 9/0866; H04L 9/3231; H04L 9/3268

(57) ABSTRACT

Systems and methods for performing zero knowledge proofs to prove a user's possession of secret data and/or biometric data without exposing such data. The methods can include receiving a certificate signing request and biometric data associated with a user; creating a stable key based at least in part on the biometric data; creating a private key based at least in part on the stable key; transmitting the private key to the user device for local storage thereon; creating a public key based at least in part on the private key; and forwarding the certificate signing request to an issuer.

### CROSS-REFERENCE TO RELATED APPLICATIONS

This application claims the benefit, under 35 U.S.C. § 119(e), of U.S. Provisional Patent Application No. 63/670,476, filed on Jul. 12, 2024, and entitled “Systems, Methods, and Protocols for Zero Knowledge Proof (ZKP) User Authentication,” the contents which are incorporated by reference as if fully set forth herein.

### TECHNICAL FIELD

The present disclosure relates generally to the field of secure authentication, particularly concerning biometric verification and verifiable credentials.

### BACKGROUND

In many contemporary authentication systems and methodologies, a number of significant issues persist that can hinder optimal security, privacy, and scalability. Of particular note, current solutions typically require one or more entities to store and manage sensitive data corresponding to registered users (e.g., biometric templates of the registered users). The storage of such sensitive information presents a persistent vulnerability. Indeed, such practices can lead to privacy risks, potential for data breaches, significant overhead costs relating to data management and compliance, and/or a heightened attack surface for malicious actors seeking to compromise biometric data.

Furthermore, existing technologies may exhibit deficiencies in providing robust and trustworthy remote verification of a user's presence. While various remote authentication methods exist, many are susceptible to dispute (e.g., fail to offer a sufficient guarantee of the user's real-time presence during authentication). These shortcomings can cause existing remote authorization systems to produce false negatives (e.g., undetected fraudulent activities and/or unauthorized access) or false positives (e.g., flagging or preventing legitimate activities or access attempts), thereby cultivating a lack of trust in digital interactions, which can be particularly harmful in situations heavily reliant on assurances that the actual user is present.

Despite ongoing efforts to improve digital identity management and remote authentication protocols, a clear need remains for improved approaches for overcoming these persistent challenges.

### BRIEF SUMMARY

These and other problems are addressed by the technology disclosed herein. Briefly described, the disclosed technology relates generally to systems and methods configured to determine or establish the presence of a registered user, without necessarily requiring the registered user to undergo typical Know Your Customer (KYC) processes. Some non-limiting examples of applications typically requiring identity establishment include opening a bank account and/or registering with a clinic or hospital, whereas some non-limiting examples of applications that do not typically require identity establishment include age verification to purchase alcohol and/or to access adult-only content websites. Such scenarios typically provide a so-called “trusted presence” for a registered user, which is defined by the registered user giving consent for the registered user to be positively authenticated by a service provider in a timely manner just before the service provider gives the registered user access to a corresponding service. For example, such a scenario can include a service provider system receiving a request (e.g., a service request, an access request) from the registered user and fulfilling the request (e.g., providing the service, providing access to one or more documents or a portal or the like) upon timely identity authentication of the registered user.

The technology disclosed here, which includes one or more Zero Knowledge Proof (ZKP) protocols are configured to prove that a requesting user (e.g., the user requesting to authentication and/or to access an account) is indeed the registered user. The disclosed authentication protocols are considered to be a zero knowledge proof because the verifying entity (also referenced herein as “verifier”) does not possess a biometric template of the registered user. Indeed, the disclosed technology can prove the presence of the user (e.g., authenticate the user, confirm the requesting user is the registered user) based at least in part on a private key (and/or one or more shards, such as a client shard and a server shard) that is functionally derived from, or dependent on, a biometric sample of the user (e.g., that has first passed a biometric liveness test). The disclosed technology can include a non-stored private key (e.g., not storing the private key at any location, storing the private key only on a user device of the user and not at a remote server) and can include reconstructing the private key without using the corresponding biometric template (e.g., only by using a stable key algorithm, such as a stable Irreversibly Transformed Identity Token (IT2) algorithm, which can use a one-way transformation and/or hashing). As a result, the proof of the possession of a private key, when used in a public-key infrastructure (PKI), can be sufficient to satisfy the ZKP protocol.

The disclosed technology provides several advantages. As a non-limiting example, in scenarios in which the authenticating system has knowledge of the identity of the registered user (e.g., as established through a KYC process), a service provider or issuer (e.g., identity service provider (ISP), attribute service provider (ASP)) is not required to store or manage the biometric template of the registered user. As another non-limiting example, in scenarios in which the authenticating system does not have knowledge of the identity of the user (e.g., no KYC involved), a service provider or issuer (e.g., ISP, ASP) is not required to store or manage the biometric template of the registered user. As yet another non-limiting example, a relying party (e.g., an entity that directly provides an actual service such as a verifier and/or a service provider) is not required to store or manage the biometric template of the registered user. And as yet another non-limiting example, a biometric service provider is not required to store the biometric template of the registered user.

The disclosed technology can include a method that can comprise: receiving a certificate signing request from a user device associated with a user; receiving, from the user device, biometric data associated with the user; creating a stable key based at least in part on the biometric data; creating a private key based at least in part on the stable key; transmitting the private key to the user device for local storage thereon; creating a public key based at least in part on the private key; and/or forwarding the certificate signing request to an issuer.

The method can comprise receiving additional user-related data.

The additional user-related data can comprise data indicative of an identification document associated with the user.

The issuer can be an identity service provider.

Creating the private key can comprise: creating a derived key based at least in part on the stable key; and creating the private key based at least in part on the derived key.

The issuer can be an attribute service provider.

The method can comprise receiving additional user-related data comprising an age-indicating image of the user.

The disclosed technology can include a system comprising: one or more processors; and memory. The memory can have instructions stored thereon that, when executed by the one or more processors, cause the system to: receive a certificate signing request from a user device associated with a user; receive, from the user device, biometric data associated with the user; create a stable key based at least in part on the biometric data; create a private key based at least in part on the stable key; transmit the private key to the user device for local storage thereon; create a public key based at least in part on the private key; and/or forward the certificate signing request to an issuer.

The instructions, when executed by the one or more processors, can cause the system to receive additional user-related data.

The additional user-related data can comprise data indicative of an identification document associated with the user.

The issuer can be an identity service provider.

Creating the private key can comprise: creating a derived key based at least in part on the stable key; and creating the private key based at least in part on the derived key.

The issuer can be an attribute service provider.

The instructions, when executed by the one or more processors, can cause the system to receive additional user-related data comprising an age-indicating image of the user.

The disclosed technology can include a non-transitory, computer-readable medium having instructions stored thereon that, when executed by one or more processors of a system, cause the system to: receive a certificate signing request from a user device associated with a user; receive, from the user device, biometric data associated with the user; create a stable key based at least in part on the biometric data; create a private key based at least in part on the stable key; transmit the private key to the user device for local storage thereon; create a public key based at least in part on the private key; and/or forward the certificate signing request to an issuer.

The instructions, when executed by the one or more processors, can cause the system to receive additional user-related data.

The additional user-related data can comprise data indicative of an identification document.

The issuer can be an identity service provider.

Creating the private key can comprise: creating a derived key based at least in part on the stable key; and creating the private key based at least in part on the derived key.

The issuer can be an attribute service provider.

The instructions, when executed by the one or more processors, can cause the system to receive additional user-related data comprising an age-indicating image of the user.

Nonetheless, the disclosed technology can enable remote verification of the registered user (e.g., over the Internet) in such a way that the presence of the registered user is sufficiently guaranteed (e.g., indisputable, cannot be disputed). Alternatively or in addition, the technology disclosed herein can enhance existing standards on verifiable credentials (VCs), such as by ensuring that the owner of a VC is indeed present (e.g., remotely and/or over the Internet).

These and other aspects, features, and benefits of the claimed innovation(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed systems and processes, and wherein:

FIG. 1 illustrates an example computing environment, in accordance with the disclosed technology;

FIG. 2 illustrates an example process for provisioning a user device, in accordance with the disclosed technology;

FIG. 3 illustrates an example process for creating and/or registering a certificate associated with the user, in accordance with the disclosed technology;

FIG. 4 illustrates an example process for authenticating a certificate associated with the user, in accordance with the disclosed technology;

FIG. 5 illustrates different example architectures for creating, registering, and/or authenticating certificate, in accordance with the disclosed technology;

FIGS. 6A-6C illustrate a schematic diagram of various zero knowledge proof processes and their operational relationships with a user's wallet, in accordance with the disclosed technology; and

FIG. 7 diagrammatically illustrates a hub and poke architecture in which a stable key wallet can function as a universal authenticator for other digital wallets and/or identity tools, in accordance with the disclosed technology.

### DETAILED DESCRIPTION

Throughout this disclosure, certain examples are described in relation to systems and methods for biometrically authenticating a requesting user using one or more zero knowledge proof (ZKP) protocols in which the verifying entity (also referenced herein as “verifier”) does not possess (e.g., have stored) a biometric template of the registered user.

The disclosed technology will be described more fully hereinafter with reference to the accompanying drawings. This disclosed technology can, however, be embodied in many different forms and should not be construed as limited to the examples set forth herein. The components and technologies described hereinafter as making up various elements of the disclosed technology are intended to be illustrative and not restrictive. Indeed, it is to be understood that other examples are contemplated. Other suitable components/technology that would perform the same or similar functions as components described herein are intended to be embraced within the scope of the disclosed systems and methods. Such other components/technologies not described herein may include, but are not limited to, for example, components/technologies developed after development of the disclosed technology. Stated differently, while numerous specific details are set forth throughout this disclosure, it is to be understood that examples of the disclosed technology can be practiced without necessarily including all such details; in other instances, well-known methods, structures, and techniques have not been shown in detail in order not to obscure an understanding of this description.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

References to “one embodiment,” “an embodiment,” “example embodiment,” “some embodiments,” “certain embodiments,” “various embodiments,” “one implementation,” “an implementation,” “example implementation,” “some implementations,” “certain implementations,” “various implementations,” “one example,” “an example,” “some examples,” “certain examples,” “various examples,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the description, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Although some aspects of the disclosed technology may be described herein with respect to a particular format (e.g., a method or process, a system configured to perform a method or process, a non-transitory computer-readable medium having instructions stored thereon for performing a method or process), it is contemplated that the disclosed technology includes other formats embodying identical or substantially similar features. For example, any aspects, elements, features, or the like described herein with respect to a method can be equally attributable to a system and/or a non-transitory computer-readable medium. As another example, any aspects, elements, features, or the like described herein with respect to a system can be equally attributable to a method and/or a non-transitory computer-readable medium. As yet another example, any aspects, elements, features, or the like described herein with respect to a non-transitory computer-readable medium can be equally attributable to a system and/or a method.

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

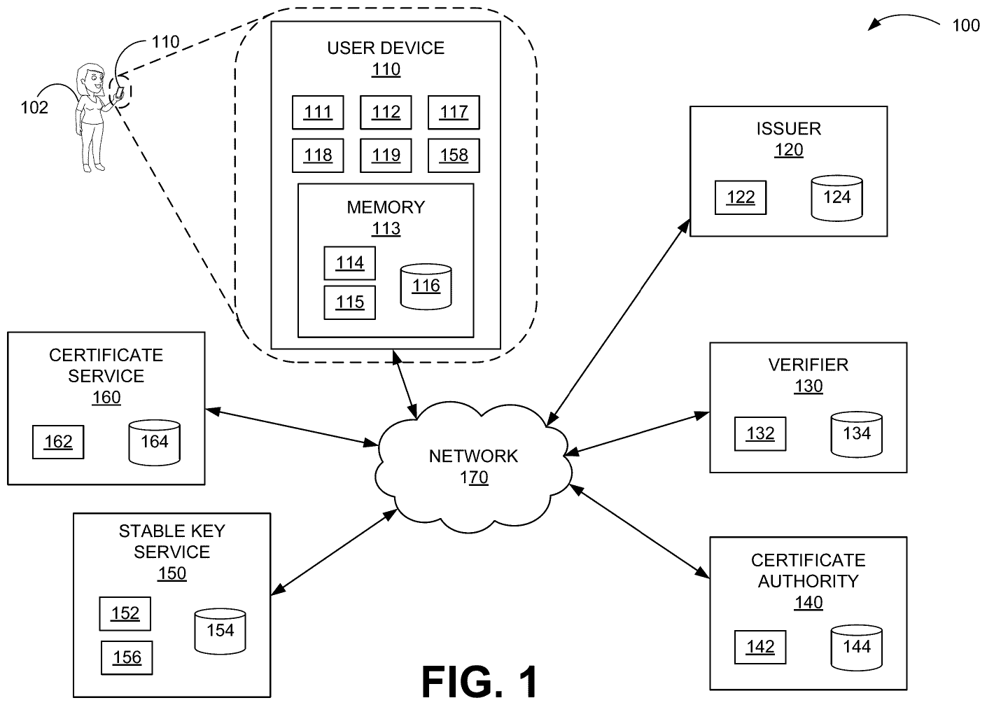

Referring to FIG. 1, an example system environment 100 is shown. As will be understood and appreciated, the example system environment 100 represents merely one approach of the disclosed technology, and other aspects, configuration, and the like are used in accordance with the disclosed technology.

The disclosed technology can include or otherwise contemplate one or more primary actors (e.g., three primary actors) and or otherwise contemplate one or more support actors (e.g., three support actors), as a non-limiting example. The term “primary actors” refers to parties that are involved in the business transaction, and the term “support actors” refers to parties that execute operations to support the business transactions. To illustrate, example parties are discussed immediately below. However, these examples are non-limiting, and the disclosed technology can include scenarios or configurations that do not necessarily include every party listed below. For example, the server component of the stable key service 150 (e.g., the stable IT2 service) is not necessarily required (e.g., if architecture (a) is being used, as described more fully herein.

The system can include a user 102 (e.g., “Alice”), which can relate to a party (e.g., human person) who wishes to be authenticated. The user 102 can be associated with a user device 110, which can be or include a computing device (e.g., a personal computer, a laptop, a mobile computing device). As shown, the user device 110 can include a processor 111; an input/output (I/O) device 112; memory 113, which can include an operating system (OS) 114, a storage device 115 (which can be or include any suitable repository of data), a program, and/or a data store 116, and/or which can be or include any type of memory, database, data repository, or the like; a communication interface 117, such as a transceiver for sending and receiving data (e.g., via Wi-Fi, cellular communications). The user device 110 can include an imaging device 118 configured to capture image data, which can be indicative of one or more images and/or one or more videos (e.g., of the user 102). The user device 110 can include one or more movement sensors 119 (e.g., one or more accelerometers, one or more gyroscopes, one or more magnetoscopes, one or more inertial measurement units (IMUs)) configured to determine a spatial position and/or orientation (e.g., “pose”) of the user device 110. The user device 110 can include a user interface (U/I) device for receiving user input data, such as data representative of a click, a scroll, a tap, a press, or typing on an input device that can detect tactile inputs. The user device 110 can include one or more additional environmental sensor for obtaining audio data (e.g., a microphone), a display for displaying images, and/or a speaker for outputting audio.

The system 100 can include an issuer 120 (e.g., an issuer computing system), which can be or include an identity service provider (ISP) or an attribute service provider (ASP), as non-limiting examples. The issuer 120 can include one or more processors 122 and one or more memory devices 124, which can include instructions for performing one or more operations, steps, actions, processes, and/or methods described herein. Alternatively or in addition, the issuer 120 can comprise one or more of the computing components, devices, and/or peripherals discussed herein with respect to the user device 110.

The system 100 can include a verifying entity 130, also referred to as a verifier 130 or a relying party, which can be or include an entity that provides a service (e.g., healthcare, goods, and/or other services). As part of service delivery, the verifier may need to confirm that the registered user has the right and/or is authorized to access the service (e.g., needs to authenticate the requesting user to confirm the requesting user is the registered user). The verifier 130 (e.g., a verifier computing system) can include one or more processors 132 and one or more memory devices 134, which can include instructions for performing one or more operations, steps, actions, processes, and/or methods described herein. Alternatively or in addition, the verifier 130 can comprise one or more of the computing components, devices, and/or peripherals discussed herein with respect to the user device 110.

The system 100 can include a Certificate Authority (CA) 140 (e.g., a CA computing system 140), which can be or include a server or computing system that certifies the issuer 120 (e.g., the ISP and/or ASP) and acts as a central point of authority for the verifier 130. The ISP and/or ASP can themselves be sub-CAs (e.g., a Certificate Authority that is itself certified by another, higher-level CA, such as a root CA), which can sign certificates (e.g., in the format of X.509 or Verifiable Credentials Data Model). The CA 140 can include one or more processors 142 and one or more memory devices 154, which can include instructions for performing one or more operations, steps, actions, processes, and/or methods described herein. Alternatively or in addition, the CA 140 can comprise one or more of the computing components, devices, and/or peripherals discussed herein with respect to the user device 110.

The system 100 can include a stable key service 150 (e.g., a stable IT2 service), which can be configured to focus on administrative operations of stable keys. The stable key service 150 (e.g., a stable key service computing system) can include one or more processors 152 and one or more memory devices 154, which can include instructions for performing one or more operations, steps, actions, processes, and/or methods described herein. Alternatively or in addition, the stable key service 150 can comprise one or more of the computing components, devices, and/or peripherals discussed herein with respect to the user device 110. As a non-limiting example, the stable key service 150 can include and/or correspond to a server component 156 (e.g., as provided by the processor(s) 152 and/or memory device(s) 154) and a client component 158, which can be installed on and/or running on the user device 110 (e.g., instructions, steps, or processes performed by the processor(s) 111 and/or stored in the memory 113). While the client component 158 can be configured to create and/or generate a stable key (e.g., a stable IT2 key), the server component 156 can be configured to provision a second device (e.g., adding a second and/or alternative device) and/or template updating, as non-limiting examples.

The system 100 can include a certificate service 160 (e.g., a certificate service computing system), which can be configured to perform operations or actions related to certificates. The certificate service 160 can include one or more processors 162 and one or more memory devices 164, which can include instructions for performing one or more operations, steps, actions, processes, and/or methods described herein. Alternatively or in addition, the certificate service 160 can comprise one or more of the computing components, devices, and/or peripherals discussed herein with respect to the user device 110. The certificate service 160 can have a client component (e.g., installed and running on the user device 110) and a server component. The client component of the certificate service 160 can be configured to provide support to enable the creation of certificate signing requests (CSRs), and the server component of the certificate service can be configured to support the backup and/or restoration of certificates. Stated otherwise (e.g., using verifiable credentials parlance), the server component of the certificate service can be known as a “verifiable data registry.”

One or more of the aforementioned devices, systems, or elements can be operatively connected to any other(s) of the aforementioned devices, systems, or elements via a network 170. The network 170 can be or include a wired network or a wireless network, such as a cellular network, a local network, etc. The network 170 can enable data (e.g., data packages and/or other electronic communications) to be transmitted and received between or among the user device 110, the issuer 120, the verifier 130, the CA 140, the stable key service 150, and/or the certificate service 160. As a specific example, some or all communications made via the network 170 can be made according to the Transport Layer Security (TLS) cryptographic protocol, and as such, the user device 110 can be enabled to verify the validity of any server or remote or backend system with which it communicates (e.g., the issuer 120, the verifier 130, the CA 140, the stable key service 150, and/or the certificate service 160). On the other hand, since a given server or remote or backend system may not recognize the user device 110, the ZKP protocol can be used to assure or reassure any server (e.g., the verifier 130) that the user 102 is indeed present at the moment of requesting access to the relevant service (e.g., the service provided by the verifier 130) via the user device 110. In other words, the trusted presence of the user 102 can be determined. As will be appreciated by those having skill in the art, the TLS protocol and/or the ZKP protocol of trusted presence can ensure two-sided authentication.

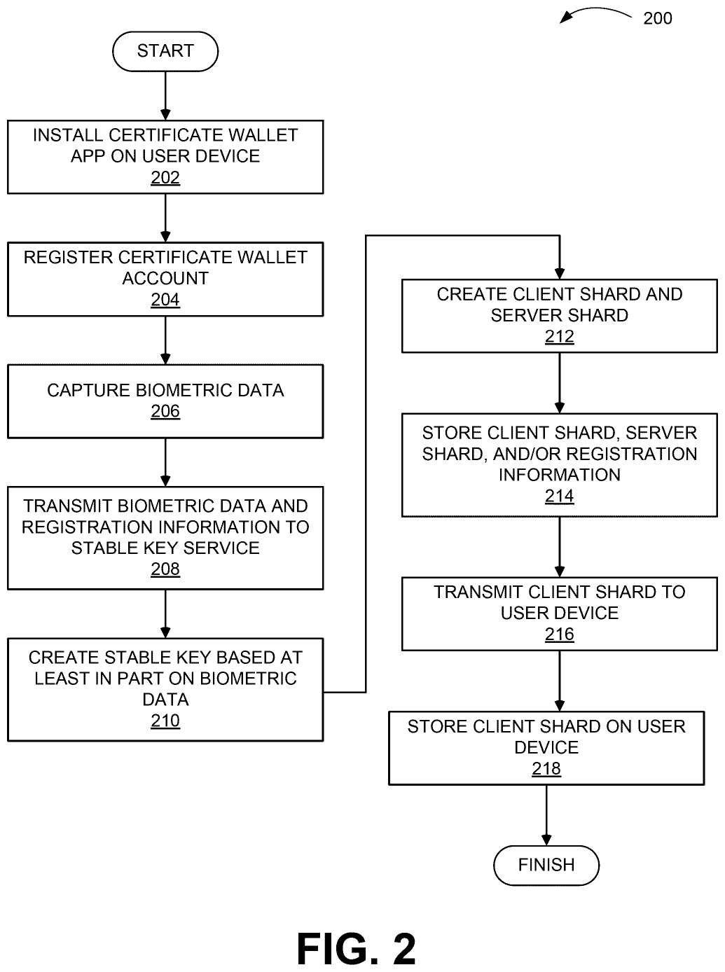

Referring to FIG. 2, an example process 200 for provisioning a user device (e.g., user device 110) is disclosed. Provisioning the user device can alternatively be referred to as creating a wallet (e.g., a ZPK wallet) on the user device. As will be explained more fully below, various steps of the process 200 can be performed by different devices/systems, actors, and/or entities (e.g., depending on the particular system architecture implemented). Regardless of any specific system architecture, the process 200 can provide a general overview of a ZPK methodology.

The process 200 can include installing 202 a certificate wallet application (e.g., corresponding to the stable key service 150) on the user device (e.g., user device 110). For example, a client component 158 of the stable key service 150 can be installed on the user device. The process 200 can include creating 204 or registering a certificate wallet account and/or stable key wallet account (e.g., providing contact information for account recovery and/or user credentials for access the certificate wallet account), which, for ease of discussion, can be collectively referred to as the registration information.

The process 200 can include capturing 206 the user's (e.g., the user's 102) biometric data (e.g., a facial image or video) and transmitting 208 the user's biometric data and the registration information to a server component 156 of the stable key service 150 for registration.

The process 200 can include generating 210 (e.g., via the stable key service 150, whether via the server component 156 or the client component 158) a stable key based at least in part on the biometric data. The term “stable key” used throughout this disclosure can be or can include a lossless fuzzy extractor, as a non-limiting example. For example, generating 210 the stable key can be performed according to the technology provided in U.S. patent application Ser. No. 18/987,822, entitled “Systems and Processes for Digital Identity Authentication via Lossless Fuzzy Extractors” and filed Dec. 19, 2024, the entire contents of which are incorporated by reference as if fully set forth herein. The biometric data (e.g., biometric template) can be discarded once the stable key has been created.

Alternatively or in addition, the process 200 can include creating 212 client shard and a server shard (e.g., based on the stable key). Stated differently, the process 200 can include sharding the stable key to create 212 the client shard and the server shard. The process 200 can include storing 214 the client shard, the server shard, and/or the registration information to one or more databases of the stable key service 150 (e.g., a write-only database). For example, the process 200 can include storing (e.g., storing only) the client shard, the server shard, and/or the registration information in a database (e.g., for wallet recovery and/or new-device provisioning purposes). Alternatively or in addition, the process 200 can include storing (e.g., storing only) the server shard and credential information of the registration information (e.g., to support certificate creation/registration and/or authentication workflows). The process 200 can include transmitting 216 (e.g., via the stable key service 150) the client shard to the user device (e.g., via the client component 158) and/or storing 218 (e.g., locally storing) the client shard on the user device (e.g., user device 110).

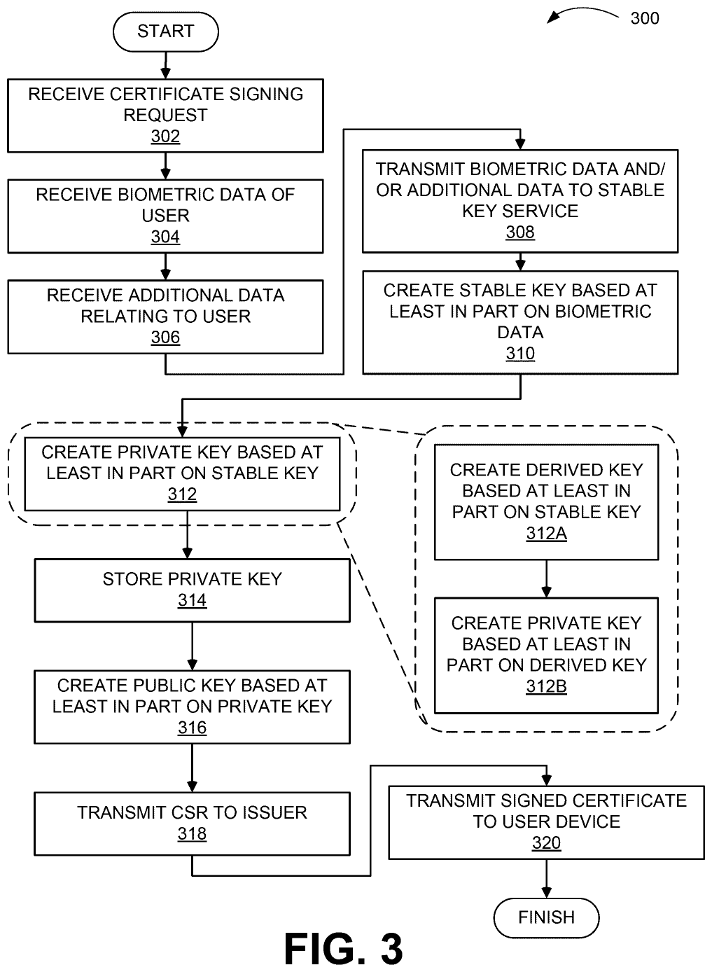

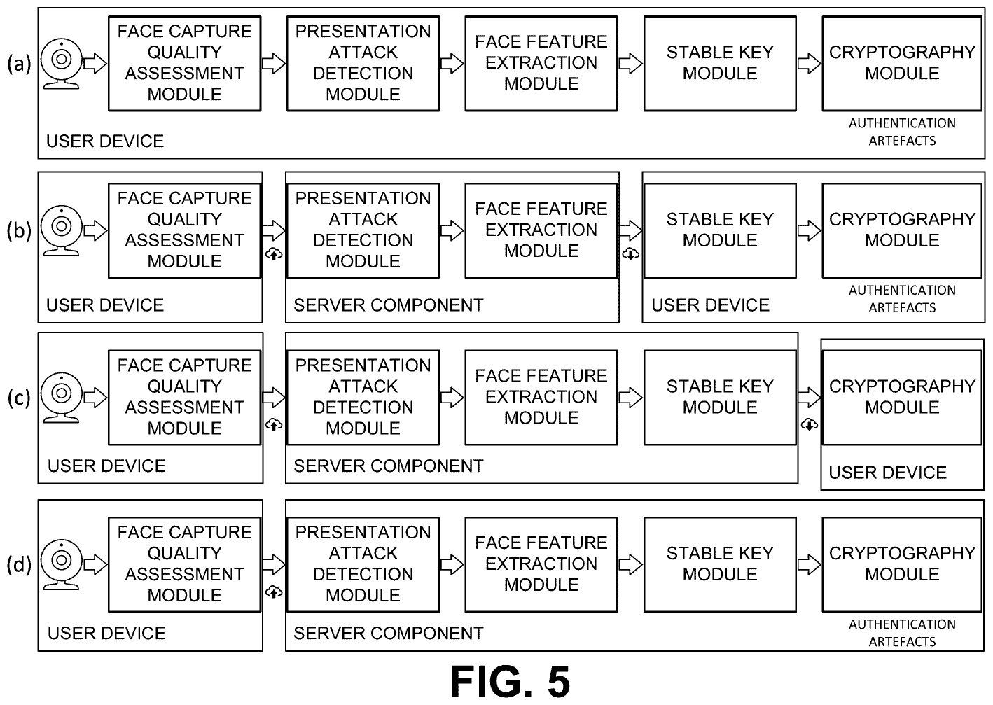

Referring to FIG. 3, an example process 300 for creating and/or registering a certificate associated with the user (e.g., user 102) in accordance with Zero Knowledge Proof (ZKP) protocols is shown. As will be explained more fully below, various steps of the process 300 can be performed by different devices/systems, actors, and/or entities (e.g., depending on the particular system architecture implemented—see, e.g., FIG. 5 and corresponding discussion). Regardless of any specific system architecture, the process 300 can provide a general overview of a ZPK methodology.

The process 300 can include receiving 302 an indication (e.g., user input received via the user device 110) of a service (e.g., an issuer 120, which can be an ISP or an ASP) for which a certificate is being requested (e.g., a certificate signing request (CSR) to be sent to an issuer 120).

The process 300 can include receiving 304 biometric data associated with a user (e.g., user 102). Receiving 302 the biometric data can include receiving biometric data that was obtained or captured by a different device, and/or receiving 302 the biometric data can include capturing or otherwise obtaining the biometric data via a corresponding biometric sensor (e.g., a camera or imaging device, although other biometric sensors are contemplated). The biometric data can comprise live scan data indicative relating to a live scan of a user (e.g., user 102), such as of a user's face. For example, the live scan be or include one or more photos and/or videos of the user's person (e.g., a selfie image or video).

Depending on the service and/or issuer 120 (e.g., ISP, ASP), additional data may be required. In such cases, the process 300 can include receiving 306 additional data relating to the user. The additional data can be or include data indicative of one or more identifying documents (e.g., a driver's license) corresponding to the user (e.g., in the case of an ISP). For example, the additional data can include one or more photos or images and/or one or more videos of a physical driver's license, passport, or the like. As another example, the additional data can include data corresponding to a mobile driver's license associated with the user. Alternatively or in addition, the additional data can be or include data indicative of one or more attributes of the user (e.g., an age of the user) and/or a certificate or degree (e.g., issued by an educational institution), such as in the case of the issuer 120 being an ASP. In such cases, the additional data can comprise one or more photos or images and/or one or more videos of the user's face (e.g., for age verification).

As a non-limiting example, the process 300 can include performing a liveness check (e.g., via the client component 158, via the server component 156) on the received biometric data and/or additional data. As another non-limiting example, the liveness check can be performed according to the technology disclosed in U.S. Patent Application No. [To Be Announced by U.S. Patent & Trademark Office], entitled “Systems and Methods for Detecting Injection Attacks in Remote Identity Proofing” and filed on Jun. 23, 2025, which depends from U.S. Provisional Application No. 63/662,575, entitled “Systems and Methods for Using Smartphone Movements to Detect Injection Attacks in Remote Identity Proofing” and filed Jun. 21, 2024, the contents of which are incorporated herein by reference as if fully set forth below.

The process 300 can include transmitting 308 the biometric data and/or the additional data to the stable key service 150 (e.g., the server component 156).

The process 300 can include creating 310 (or re-creating) a stable key using the biometric data. For example, the stable key service 150 can retrieve the server shard and/or client shard corresponding to the wallet of the user 102 and/or user device 110 in order to reconstruct the stable key corresponding to the user 102 (e.g., using the client shard, the server shard, and/or the received biometric data). If successful, the reconstructed stable key can be sent to the client component 158 on the user device 110, as a non-limiting example. Alternatively or in addition, this wallet verification process can be performed in part or in whole by the server component 156 (e.g., to avoid transmission of the stable key over the Internet and/or the network 170). In this scenario, the server component 156 can be configured to fetch the server shard and transmit the server shard to the client process 158, and the client process 158 can reconstruct the stable key (e.g., using the locally stored client shard, the server shard, and/or the biometric data) locally on the user device 110.

The process 300 can include creating 312 a private key based at least in part on the stable key. Stated differently, the stable key can be used to decrypt a previously encrypted version of the data to be able to derive and/or recover the private key, and as such, it can be said that the private key is functionally dependent on the stable key. The process 300 can include creating 312 the private key directly from the stable key. In such a case, the stable key can be referred to as a weak biometric bound credential (e.g., as disclosed by U.S. patent application Ser. No. 18/987,822). The adjective “weak,” as used here, simply implies that the functional dependency of the private key to the user's biometric trait (e.g., as indicated by the user's biometric data) is to the extent that the private key is encrypted using the user's stable key. One tradeoff of a weak biometric bound credential is that while it may be less secure than a strong biometric bound credential, it can enable binding to other credentials (e.g., a recovery password, a hardware-bound token) as an alternative means to decrypt the user's private key.

Alternatively or in addition, creating 312 the private key can comprise creating 312A a derived key based at least in part on the stable key and creating 312B the private key based at least in part on the derived key. Stated differently, the stable key derived from the user's biometric trait or template (e.g., as indicated by the user's biometric data) can be used to directly derive an account-specific and/or application specific credential, such as by using a key-derivation function (KDF). The KDF can diversify the stable key using, as an initialization vector, the application name (which can be a string field detailing the application in question, e.g., “age check”), a qualification awarded by an academic institution, and/or a string version of a counter (e.g., concatenated string+“03”), as non-limiting examples. As another non-limiting example, the KDF can be represented as

$$derived\_key = KDF ( entropy = codeword , initialization\_vector = application\_name ) ,$$

where the term “codeword” can refer to the stable key and/or one or more lossless fuzzy extractors (see, e.g., U.S. Provisional application Ser. No. 18/987,822). The adjective “strong,” as used here, implies that the private key is derived from a derived key that is (1) derived from the stable key and (2) a source entropy for creation of the resultant private key.

The process 300 can include storing 314 the private key. The private key can be stored on a user device 110 associated with the user 102, as a non-limiting example. Alternatively or in addition, the private key can be encrypted at all times (e.g., in a digital wallet, in a data vault). This can simply be or include a data container containing encrypted data. In a very simple case, this can be or include a password-protected ZIP file format. Only the user's 102 stable key can decrypt the wallet. This process can create a functional dependency of the private key on the user's 102 biometric traits or templates (e.g., biometric data). As explained in more detail herein, this functional dependency, also known as biometric-bound credentials, can be considered weak or strong.

Regardless of how the private key is created, the process 300 can include creating 316 a public key based at least in part on the private key.

The process 300 can include transmitting 318 a certificate signing request (CSR) to the issuer 120 (e.g., an ISP, an ASP) and/or one or more publicly accessible datastores (e.g., one or more trusted databases, one or more government ID databases, one or more decentralized databases such as one or more distributed ledgers). The CSR can include the public key and/or the additional data. As explained more fully herein, while the public key can be stored by a third party (e.g., an issuer 120 and/or one or more publicly accessible datastores), the process 300 contemplates that no such party can have a stored copy of the user's biometric data. Indeed, a benefit of the process 300 (and the technology disclosed herein, generally) is that a user can be authenticated without requiring the user's biometric data to be stored by any party, device, or system. In contrast, the functional equivalent of a traditional biometric reference (at least for the purposes of the disclosed technology) can be provided by the stable key service (e.g., by the stable key service 150). Upon confirming that the data included in the CSR is true, the issuer 120 can request a certificate service 160 to sign the CSR on the issuer's 120 behalf. The certificate service 160 can act as a certificate registry that can store signed certificates (e.g., for recovery purposes) and/or maintain a list of revoked certificates. The process 400 can include transmitting 320 (e.g., via the certificate service 160, via the issuer 120) the signed certificate to the user device 110 for safekeeping. Stated differently, the user device 110 can receive and store the signed certificate or credentials.

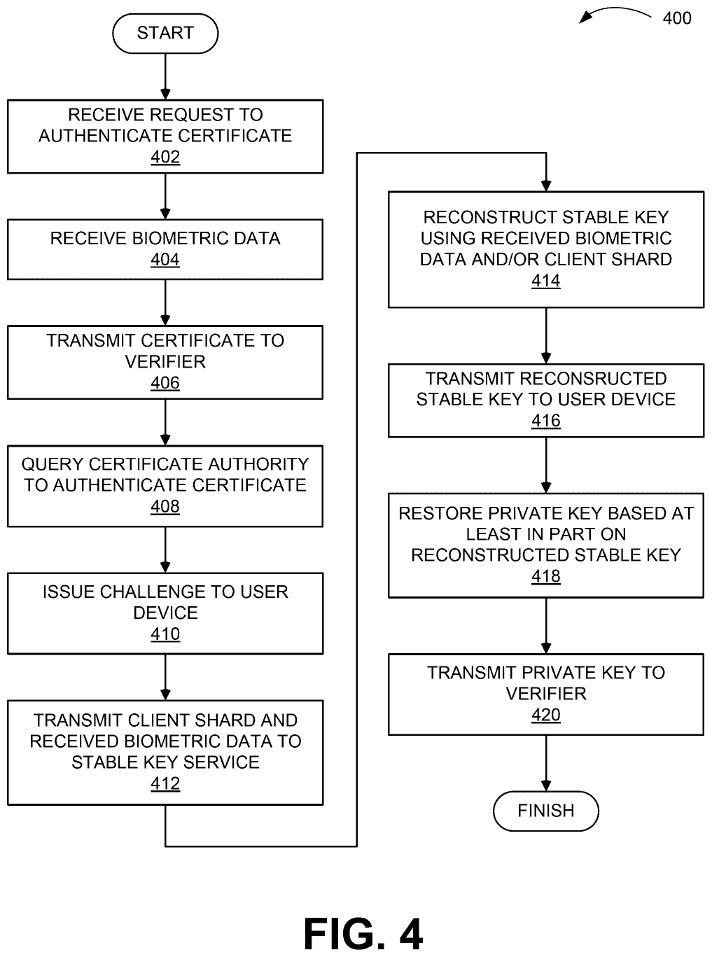

Turning now to FIG. 4, an example process 400 for authenticating a user's certificate or credentials is shown. As will be explained more fully below, various steps of the process 400 can be performed by different devices/systems, actors, and/or entities (e.g., depending on the particular system architecture implemented). Regardless of any specific system architecture, the process 400 provides a general overview of a ZPK methodology.

The process 400 can include receiving 402 a request to authenticate a signed certificate (e.g., via the user device 110). The process 400 can include receiving 404 biometric data of a user (e.g., user 102). Receiving 402 the biometric data can include receiving biometric data obtained by a separate device, and/or receiving 402 the biometric data can include capturing or otherwise obtaining the biometric data by a corresponding biometric sensor (e.g., a camera or imaging device, although other biometric sensors are contemplated). The biometric data can comprise live scan data indicative relating to a live scan of a user (e.g., user 102), such as of a user's face. For example, the live scan be or include one or more photos and/or videos of the user's person (e.g., a selfie image or video).

The process 400 can include transmitting 406 the certificate to a verifier 130 or relying party. The verifier 130 can query 408 a CA 140 to confirm the validity of the received certificate. As a non-limiting example, the CA 140 can be part of the trust chain that vetted the certificate service (see, e.g., process 300). (Alternatively, the role of CA can be performed by the certificate service.)

If the CA determines the certificate to be valid, the verifier 130 can issue 410 a challenge to the user device 110 (e.g., the client component 158 running on the user device 110).

To respond to the challenge directly, the user device 110 would need to prove possession of the corresponding private key, which it does not have. Therefore, to proceed, the user device 110 (e.g., the client component 158) can transmit 412 the client shard (e.g., locally stored) and the received biometrics data to the stable key service 150 (e.g., the server component 156).

The process 400 can include reconstructing 414 (e.g., via the stable key service 150) the stable key corresponding to the user 102 using the received client shard, the received biometrics data, and the server shard corresponding to the user device 110 (e.g., stored by the stable key service 150).

The process 400 can include transmitting 416 (e.g., by the server component 156 of the stable key service 150) the reconstructed stable key to the user device 110 (e.g., the client component 158). Alternatively or in addition, the process 400 can include restoring 418 the private key based at least in part on the reconstructed stable key (e.g., in the same or similar manner as step(s) 312 of process 300) and transmitting 420 the private key to the verifier 130 (e.g., as a response to the challenged issued by the verifier 130). If the response is correct, the verifier 130 can authorize 422 access for the user device 110.

The exchanges of information between the client and the server(s) can be vastly reduced when the wallet registration and wallet verification run on the user's device 110. Moreover, the user's device 110 can be configured to communicate (e.g., directly, via the network 170) only with the ISP/ASP and the verifier 130. In this paradigm, a wallet-and-certificate backup process can be established to ensure prompt restoration of Alice's wallet and certificate if Alice's device is lost or become nonfunctional.

To that end, four example system architectures (e.g., architectures (a)-(d)), each being configured to perform one or more certain processes (e.g., process 200, process 300, process 400), in whole or in part, are now discussed with respect to FIG. 5. As stated elsewhere herein, the server component 158 of the stable key service is not necessarily required (e.g., if architecture (a) is being used). To that point, the manner in which the stable key algorithm is executed can affect how, inter alia, the client component 158 and the server component 156 work together.

In architecture (a), all processes related to the processing of the biometric data (e.g., the facial capture and quality assessment modules, the face presentation attack detection (PAD) module (e.g., analyzing for injection attacks), the feature extraction module, and/or execution of the stable key algorithm (for registration and/or authentication), and the execution of cryptography modules (including, but not limited to, PKI, symmetric/asymmetric encryption, and/or FIDO2 protocols), the creation and/or storage of certificates, and/or responding to cryptographic challenges can be performed by (or on) the client side (e.g., via the client component 158). Stated differently, all such operations can occur on, or be performed by, the user device 110.

In architecture (b), the PAD module and feature extraction can be performed by the server (e.g., the stable key service 150 or another remote computing system), and the rest of the components and/or operations discussed herein can be performed by the user device 110. This scenario can be useful when devices (e.g., user devices 110) are not sufficiently performant to run all components (which can be computationally intensive). In this scenario, the biometric data can be uploaded to the server side (e.g., the stable key service 150 or another remote computing system) from the user device 110 (denoted as a cloud symbol with an upward arrow), and the user device 110 can download (denoted as a cloud symbol with a downward arrow) a biometric template (e.g., the result of the feature extraction module), which can help enable the stable key algorithm receive the extracted biometric template as an input and process the biometric template (e.g., for registration and/or authentication).

Architecture (c) can be substantially the same as architecture (b) except that the server can also be configured to perform the stable key algorithm component. The user device 110 can download the stable key, which the user device 110 can diversify to create new cryptographic keys. This architecture can be useful to help prevent the stable key algorithm from being run on compromised devices.

In architecture (d), the user device 110 can be configured to act as an image-capturing and/or video-capturing device, and the server can be configured to receive the captured image/video data (e.g., biometric data) from the user device 110 and perform all processing steps and/or components. Although this scenario may offer convenience for the user device 110 and/or user 102 (e.g., since nothing is stored locally on the user device 110), it also means that the server is entrusted with executing all cryptographic operations. In this scenario, the client shard, which can be represented in the form of a Binary Large Object (BLOB) (and which can be one of the outputs produced by the stable key registration operation) needs to be stored in a database accessible by the stable key service 150.

Architectures (a)-(d) can be considered to represent examples of a spectrum of acceptable levels of trust placed on the server (e.g., a spectrum ranging from placing no trust in the security afforded by the server to placing full trust in the security afforded by the server). Arguably, architecture (a) is the most secure solution but is also the most computationally demanding architecture for the user device 110.

The stable key service 150 can additionally play two roles. First, it can facilitate the user's 102 experience by (a) supporting account recovery (e.g., in case the user 102 loses his/her device), (b) provisioning a second device, and/or (c) implementing a custodian protocol by which someone other than the registered user 102 (e.g., a secondary user) is provided a means to recover the registered user's private key. Second, it can ensure device security, such as by storing one of the two-part registration artefacts. Stated differently, the stable key service can store the server shard (e.g., in the form of BLOB), which the user device 110 can download and use (e.g., handle in an ephemeral manner) prior to authenticating the user 102 via the stable key algorithm. The term “ephemeral” refers to the device storing the server shard in memory for only a brief duration (e.g., during the authentication process) and immediately purging the server shard once the user has been authenticated.

Once a user device 110 is provisioned, the user device 110 alone can be sufficient to execute the ZKP protocols (e.g., without the server component of the stable key service). Stated otherwise, once the user device 110 is provisioned and ready to operate and execute the ZKP protocol, only the client component 158 of the stable key service is needed, according to at least some architectures. So, for the purpose of describing the ZKP protocol herein, the description can begin with the user device 110 producing a stable key. Additional details of such a “stable key account registration” stage are provided in U.S. patent application Ser. No. 18/987,822, entitled “Systems and Processes for Digital Identity Authentication via Lossless Fuzzy Extractors” and filed Dec. 19, 2024, the entire contents of which are incorporated by reference as if fully set forth herein.

In a similar vein, this disclosure does not discuss the certificate service 160 in detail. In practical deployment, this server can be particularly useful in certain scenarios, such as if the user 102 were to lose her user device 110 (or the user device 110 becomes non-functional), such that the user 102 needs a mechanism or functionality to restore previously signed certificates.

The stable key service 150 and/or the certificate service 160 (e.g., PKI certificate service) can communicate with the user device 110 directly (or via the network 170). Alternatively, the stable key service 150 and/or the certificate service 160 can coordinate so that the user device 110 is required to communicate with a single, unified service (e.g., both services communicate with the user device 110 via an intermediary communication device or service, one service communicates with the user device 110 directly and the other service communicates with the user device 110 via the one service). For example, the user device 110 can initially communicate with a vendor (e.g., a reseller of the ZKP authentication technology disclosed herein), and at this stage, a unified service has no direct communication with the user device 110. In this scenario, the vendor can register the user device 110 and then transfer communication responsibilities to the unified service to thereby enable the user device 110 to communicate directly with the unified service (e.g., without involving the intermediary of the vendor's service).

As discussed elsewhere herein, the disclosed technology can be used for remote identity proofing involving an identity service provider (ISP) and/or without remote identity proofing but attribute checking, involving an attribute service provider (ASP). That is to say, an example registration workflow (see, e.g., process 200) can be followed by an example authentication workflow for ZKP protocols with Know Your Customer (KYC) functionality (see process 300 including steps 312A and/or 312B) or followed by an example authentication workflow for ZKP protocols without KYC functionality (see process 300 omitting steps 312A and/or 312B). In either case, the user 102 and/or user device 110 can be remotely located (e.g., relative to the authentication system). For example, the issuer 120 and/or the verifier 130 can communicate with the user device 110 remotely (e.g., over the Internet, via the network 170).

For clarity, the ISP scenario can differ from the ASP scenario at least because, in the case of an ISP, an identification document can be presented to the issuer 120, and the issuer 120 can rely on, or play the role of, an ISP to confirm the identity of the user 102 upon registration. However, in the case of the ASP scenario, no identification document is involved, and the issuer 120 can instead play the role of an ASP (e.g., one who estimates an attribute claimed by the user). For example, an ASP can provide age estimation as a service (e.g., in which case the age is an attribute claimed by the user 102, such as the user claiming to be over a certain age, for example 18 or 25). Another example attribute can include a certificate or degree (e.g., issued by an educational institution).

Despite biometric data relating to the user 102 being used in both, the identity of the user 102 is known in the ISP scenario but is not known in the ASP scenario. In the ASP scenario, all that is required is that the registered user 102 and the requesting user (e.g., appearing at a later stage of authentication) are determined to be the same user (e.g., the same person). In the ASP scenario, the exact identity of the user 102 is not known because no KYC steps or protocols have been performed.

### EXAMPLE USE CASE(S)

Consider an example scenario in which a user, Alice (e.g., user 102), interacts with an employment agency (e.g., a verifier 130 or relying party) to look for a job. For the sake of discussion, the communication between Alice and the employment agency can be done over the Internet (e.g., network 170). The employment agency can first establish the identity of Alice and subsequently verify her qualifications. For the establishment of identity, using an example ZKP protocol, the employment agency can check with the government agency that issues drivers' licenses or passports, as non-limiting examples, and as such, the government agency can serve as an identity service provider (ISP) (e.g., issuer 120). The employment agency can also check with the educational institution from which Alice claims she graduated, and the educational institution can thus act as an attribute service provider (ASP) (e.g., issuer 120). When the various parties (e.g., the ISP, the ASP, the verifier 130, and/or the user device 110 of the user 102) use the ZKP protocol, Alice's job application—and the authentication and/or verification thereof—can be conducted entirely online.

The ZKP protocol can provide a high level of authentication assurance (e.g., Authenticator Assurance Level 3 (AAL3) according to the NIST Special Publication 800-63-3 (June 2017, including updates as of Mar. 2, 2020) on digital identity guidelines). AAL3 corresponds to “High Assurance MFA” and can involve the use of hardware-based authenticators and cryptographic mechanisms to provide high levels of assurance (e.g., the highest level of assurance). Alice's registered device (e.g., the user device 110), combined with a cryptographic key hashed from Alice's biometric data, can qualify as a multi-factor authentication (MFA) using cryptographic mechanisms. While the standard AAL3 includes protections against phishing, replay attacks, and other sophisticated impersonation attempts, it does not prevent attackers who have successfully compromised (e.g., unlocked or otherwise accessed) Alice's device. The disclosed technology, however, does help to prevent such an attack at least because the required counterpart cryptographic material can be derived only from Alice's biometric data, which is not stored on Alice's device. In essence, biometrics, coupled with a strong liveness check, can serve as a non-repudiable claim that Alice was the person remotely applying for the job.

### ZKP Determination of Genuine Human Presence

To determine a genuine remote presence of the registered user and to consider that determination to be valid and irrefutable, the ZKP protocol can require that one or more conditions be satisfied. For example, the ZKP protocol can require one, some, or all of the following conditions:
1. On-Device Biometric Processing Without Storage. Continuing the above example, the employment agency (e.g., verifier 130) can lack (e.g., not possess, store, and/or have access to) Alice's biometrics, as in this example, the employment agency has never previously encountered or known Alice. However, the ASP and/or ISP have separately encountered Alice, and as such, Alice can have previously deposited a public certificate (e.g., containing a corresponding public key) with the ASP and/or ISP or with some publicly accessible datastore (e.g., one or more trusted databases, one or more government ID databases, one or more decentralized databases such as one or more distributed ledgers). Further, Alice can have stored, or can have access to, one or more private keys (e.g., a separate and distinct private key for each application) to herself (e.g., stored on Alice's user device). Furthermore, no party, including the ASP and/or ISP, can have a stored copy of Alice's biometric template (or any other biometric data). Indeed, utilizing the stable key algorithmic construct can result in no biometric template needing to be stored by any party, device, or system. In contrast, the functional equivalent of a traditional biometric reference (at least for the purposes of the disclosed technology) can be provided by the stable key service (e.g., stable key service 150, a stable IT2 service). For example, the functional equivalent of a traditional biometric reference can be provided in the form of a two-part registration artefact, such as the two-part registration artefact explained above that can include a client shard stored on Alice's device and a server shard stored at a remote server (e.g., a server of the stable key service 150). A first part of the registration artefact (e.g., the client shard) can be stored on Alice's provisioned device (or multiple provisioned devices), and a second part of the registration artefact (e.g., the server shard) can be downloaded (to Alice's device, for example) from the stable key server (e.g., stable key service 150) on demand (e.g., for each authentication session). As will be appreciated, simply combining the client shard and the server shard would not enable an attacker to reconstruct Alice's biometric template or steal her stable key (or the private key that the stable key has encrypted). In short, the stable key algorithm can require a particular device to capture and process Alice's samples, and as such, the stable key algorithm can prevent any other single party from directly handling or processing Alice's biometric sample.
2. Spoof Resistance. The non-repudiation property of Alice's remote presence can be satisfied if (e.g., only if) Alice's device is tamper-resistant (e.g., it is guarded against injection and presentation attacks). Whereas an injection attack aims to play back a previous digital scan of Alice's biometric trait (e.g., Alice's face image) from a virtual camera, thus bypassing a physical camera, a presentation attack involves simply showing a printed photo of Alice's biometric trait on a printed media or a display or screen.
3. Biometric-Bound Credentials. The private key(s) that reside on Alice's device can be encrypted at all times (e.g., in a digital wallet, in a data vault). This can simply be or include a data container containing encrypted data. In a very simple case, this can be or include a password-protected ZIP file format. Only Alice's stable key (e.g., the secret derived from Alice's biometric trait using the stable key algorithm) can decrypt the wallet. This process can create a functional dependency of the private key on Alice's biometric traits. As explained in more detail herein, this functional dependency, also known as biometric-bound credentials, can be considered weak or strong.
4. Certificate Authentication. This can refer to a standard cryptographic protocol that can be used by the employment agency (e.g., verifier 130) to prove that Alice possesses the private key used in the creation of a public certificate (e.g., claiming either her identity or her attributes). For example:
   a. Alice's device can present a public certificate to the employment agency (e.g., verifier 130);
   b. the employment agency (e.g., verifier 130) can verify the certificate with the ISP and/or ASP (e.g., ensuring that the certificate is genuine and valid.);
   c. the employment agency (e.g., verifier 130) can then issue a challenge to Alice's device; and
   d. Alice's device can respond to the challenge. If the response is correct, the employment agency (e.g., verifier 130) now knows that Alice's device indeed possesses the private key that was used during the creation of the public certificate.
5. Trust on the ISP and/or ASP. The ZKP protocol can require the verifier (e.g., verifier 130) to trust the ISP and/or the ASP (e.g., issuer 120). To this end, the verifier can be required to authenticate the party (e.g., using standard authentication protocols).

With the above conditions in place, Alice's remote presence, from the relying party's (e.g., the verifier 130) is perspective, cannot be refuted.

While the ZKP protocol of genuine remote user presence is sound and can withstand the majority of cyber-attacks, it is not a solution that is designed to withstand coercion attacks or attacks mounted by a highly motivated nation state targeting a specific victim. For example, if Alice is coerced to providing her biometric traits using her provisioned device, the four requirements for the ZKP protocol are still satisfied and valid. Under a nation state attack willing to spare no expenses, an extremely sophisticated injection attack could potentially bypass the device's injection attack detection and presentation attack detection mechanisms. Therefore, the ZKP protocol cannot replace the highest levels of identity and authentication assurance that require Alice's physical presence. On the other hand, in view that physical certificates can be easily spoofed and fabricated with high realism, the proposed ZKP protocol for attribute authentication using a biometric bound credential is arguably more superior and tamper resistant than its physical counterpart.

### The ZKP Protocol

Let us assume that Alice, at this point, is registered with the stable key service and has already set up or provisioned her device. As such, Alice is ready to initiate the certificate creation and/or authentication protocols (e.g., by asking her device to create or recreate a stable key). Once the device is set up, the ZKP protocol can now begin with a registration workflow, followed by an authentication workflow. Note that while ISPs and ASPs can have different registration workflows, they can share the same authentication workflow. As such, two different registration workflows are discussed below, followed by discussion of a single, common authentication workflow.

Registration with an ISP

As an unregistered user, Alice can undergo a remote identity proofing process by claiming her identity is the same as an identity associated with an identification document issued by a government agency (see process 300 including steps 312A and/or 312B). This can include the user taking a selfie video of his or her person (e.g., face), along with an image or video of the corresponding identification document. The ISP can confirm the claimed identity to belong to the user (e.g., Alice) after performing a corresponding check and determining a match. Once Alice's claimed identity has been confirmed, Alice can receive a public certificate signed by the ISP. A more specific discussion of an example protocol using a strong biometric bound credential follows:
1. Alice's device can recreate her stable key using Alice's live-scanned face.
2. Alice's device can create an application-specific derived key (e.g., using a KDF function with the ISP name).
3. Alice's device can create a private key using the derived key (e.g., by taking the derived key as a seed value input to a KDF).
4. Alice's device can (but is not required to) encrypt the private key using the stable key.
5. Alice's device can generate a public key using the private key.
6. Alice's device can use the private and public key pair to create a certificate signing request (CSR), adding the claimed identity information to be verified by the ISP.
7. Alice's device can send the CSR to the ISP.
8. The ISP can verify the claimed identity information by carrying out the remote identity proofing process.
9. If Alice's identity is confirmed to be the same as Alice's claimed identity (e.g., using her identification document), the ISP can sign the certificate and transmit the signed certificate to Alice for safe keeping.

If the protocol is executed correctly, Alice's device can include (i) an encrypted private key and (ii) a certificated signed by the ISP, which also includes the public key created for this purpose. Upon completion of this registration process, Alice is now known as the registered user.

Registration with an ASP

Registration with an ASP can include steps that are similar to the steps for registering with an ISP, except that steps 8 and 9 are different (because an ASP's functions are different from an ISP's functions).
1. Alice's device can recreate her stable key using Alice's live-scanned face.
2. Alice's device can create an application-specific derived key (e.g., using a KDF function with the ASP name).
3. Alice's device can create a private key using the derived key.
4. Alice's device can (but is not required to) encrypt the private key using the stable key.
5. Alice's device can generate a public key.
6. Alice's device can use the private and public key pair to create a certificate signing request (CSR), adding the attribute claim to be verified by the ASP.
7. Alice's device can send the CSR to the ASP.
8. The ASP can verify the claimed attribute by carrying out a corresponding check. For example, for age verification, the ASP can require the device to send Alice's life-scanned face image so that her age can be estimated.
9. If Alice's claimed attribute is confirmed within an acceptable error margin (e.g., Alice's visual appearance in the life-scanned face image is determined to be within an acceptable error margin of the age claimed by Alice), the ASP can sign the certificate and the signed certificate to Alice for safe keeping.

### Authentication

To prove Alice's identity or attribute to a relying party (e.g., the verifier 130), the ISP and/or ASP must confirm that (i) the certificate from Alice is genuine and valid and (ii) Alice possesses the private key that was used to create the certificate using the above ZKP protocol.
1. Alice's device can send her certificate to the relying party.
2. The relying party, acting as a verifier 130, can check that the presented certificate is genuine and valid. This validity can be traced back to a CA trusted by the verifier.
3. If the certificate is confirmed to be valid, the verifier can send a challenge to Alice's device. This can be done, for example, by creating a nonce (a random string), encrypting it with the public key obtained from the verified certificate, and sending the encrypted nonce to Alice's device.
4. Alice's device can decrypt the private key using Alice's stable key, which Alice's device can generate or derive from Alice's live-scanned face.
5. Alice's device can respond to the challenge by decrypting the encrypted nonce using the private key.
6. The verifier can determine whether the response from Alice's device is equal to the nonce generated in step 3. If they are the same, it can be determined that Alice's device is the device that contains the private key, which could be obtained only if Alice is truly in possession of the device. Therefore, Alice's genuine life presence can be demonstrated.
   This can complete the ZKP authentication protocol.

### Overall Workflow

To provide a tangible example of the ZKP protocol of trusted presence, it can be instructive to describe the protocol using a certificate wallet to demonstrate the interaction between Alice (e.g., the user 102 and/or the user device 110), and the ISP/ASP (e.g., the issuer 120), and/or the verifier 130. These process can include:
1. Creation of a Certificate Wallet. Alice, the user, can simply download an app to register and create a certificate wallet (e.g., process 200), which can effectively be a data vault or database or data store that can store various digital certificates (e.g., X.509), W3's verifiable credentials, FIDO passkeys, and/or any form of cryptographic secrets, including private keys and/or passwords.
2. Certification Creation/Registration Workflow. Alice can undergo the registration process described herein (e.g., process 300) with the goal of obtaining a certificate issued by an ISP or an ASP via her trusted presence. For example, to claim that she owns the digital identity associated with a mobile driver's license issued by an official government agency, Alice could undergo a remote identity proofing process provided by an ISP, the result of which can be a digital certificate that Alice can store in her certificate wallet. This process can bind Alice's biometrics to this digital certificate, which she can subsequently use to prove her trusted presence to any verifier, via the disclosed ZKP protocol. Alternatively or in addition, Alice can bind her paper-based education qualification using her biometric data to obtain a digital biometric-bound certificate, which she can store in her certificate wallet.
3. Certificate Authentication Workflow. To prove her eligibility to a verifier, Alice can “open” her certificate wallet, retrieve the certificate, and transmit the certificate to the verifier, and the verifier can authenticate the certificate, having the assurance of Alice's trusted presence.

The various devices, entities, and/or actors can combine to form different system architectures, such as those discussed herein with respect to FIG. 5. To achieve the functionality described herein, the various devices (e.g., Alice's device and one or more servers or backend systems) can communicate with each other (e.g., using standard internet or other communication protocol(s)). as a specific example, the Transport Layer Security (TLS) cryptographic protocol can be used for this purpose, and as such, Alice's device can verify the validity of any server with which it communicates. On the other hand, since any servers may not recognize Alice's device, the ZKP protocol can be used to assure or reassure any server (e.g., the verifier 130) that Alice is indeed present at the moment of requesting access to the relevant service (e.g., the service provided by the verifier 130). In other words, Alice's trusted presence can be determined. As will be appreciated by those having skill in the art, the TLS protocol and/or the ZKP protocol of trusted presence can ensure two-sided authentication.

Continuing the above example, Alice can access the service provided by a verifier using any device and not just the specific device that she used to register for a certificate wallet or the specific device that she used to register a certificate using her wallet. In other words, the disclosed technology can be configured to enable Alice's wallet to “follow” her from device to device. To take advantage of this benefit of the disclosed technology, Alice need only to provision a second device (e.g., using her primary device, directly provisioning the second device via a wallet server).

It is to be understood that the various processes and workflows (e.g., the three steps specifically discussed above) described herein are merely illustrative, and the disclosed technology is not so limited. Indeed, the disclosed technology can include various steps, methods, processes, and/or protocols that include one, some, or all of the above steps, processes, protocols, or workflows. Further, the disclosed technology includes steps, methods, processes, and/or protocols that omit one or more steps of a method or process described herein, that combine one or more of the methods or processes described herein (or any portion(s) thereof), and/or methods or processes including one or more additional steps note expressly described herein.

### Wallet Lifecyle

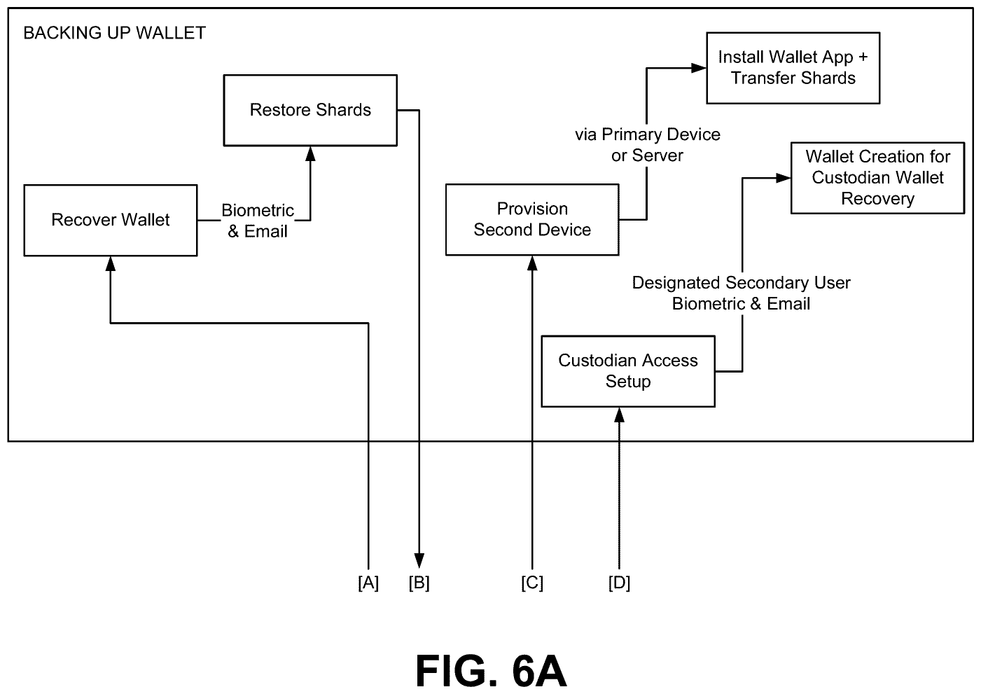

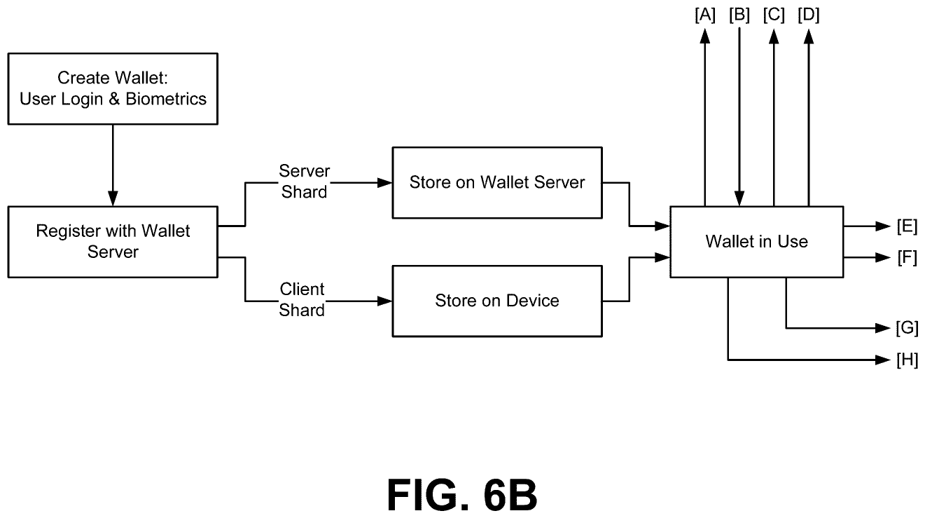

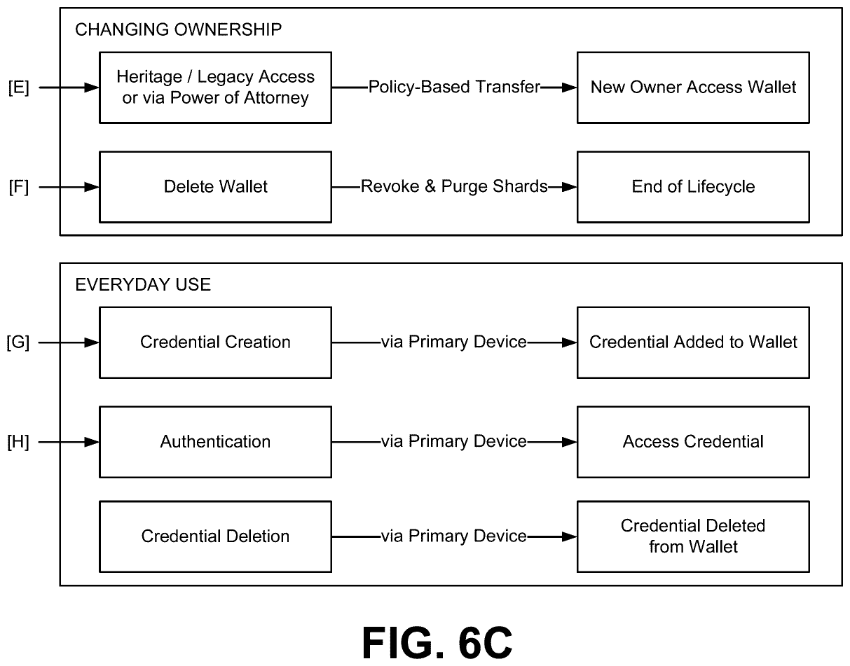

Much of the preceding disclosure can be categorized into three broad, practical uses of the ZPK technology: (1) every usage, (2) wallet backups, and (3) ownership changes. FIGS. 6A-6C show a schematic diagram of various example processes and functionalities used across these use cases, as well as the relationships between the user's wallet and such processes and functionalities.

Everyday usage of the ZPK technology can start with credential creation. This state can represent the process (e.g., process 300) in which a user (e.g., user 102) initiates the generation of a new credential, such as a digital certificate, passkey, or verifiable credential, as non-limiting examples. The credential is often derived from, or encrypted using a key that is functionally bound to the user's biometrics via the stable key (e.g., stable IT2 algorithm). This ensures that only the user can access or utilize the credential, even if it's stored externally.

Once created, the credential can be securely added to the user's wallet (e.g., a wallet application on the user device, see, e.g., step 202 of process 200). This can include binding the credential to the wallet's encrypted store (e.g., client shard) and can include storing a backup (e.g., a backup client shard, a backup credential) in a certificate registry or similar. At this stage, the credential can become available for authenticated usage from the user device.

When the user wants to use a stored credential (e.g., for logging into a service), he or she can initiate the authentication process in connection with the intended service. This typically includes providing live biometric input (e.g., via the user device 110), which triggers reconstruction of the stable key, in accordance with the technology discussed herein. The reconstructed stable key can be used to decrypt the private credential and/or or prove possession via zero knowledge proof (ZKP) protocols, without exposing any secrets.

If authentication is successful, the wallet can grant access to the requested credential, allowing the user to complete their intended action (e.g., login to a service, prove age, sign a document). The process can be seamless and/or privacy-preserving, as the user's biometric data is not stored or transmitted.

At any point, the user may choose to revoke or delete a credential. This could be due to expiration, replacement, compromise, or simply no longer needing it. To delete a credential, the user (e.g., user 102) can delete any locally stored information relating to a particular credential and/or can submit a deletion request (e.g., via the user device 110) to the pertinent server (e.g., stable key service 150, issuer 120) to delete the credential The deletion process can ensure secure erasure of the credential from local and/or server-side stores. Following deletion, the credential can be removed from the wallet's data store (e.g., on the user device 110), rendering it inaccessible to the user 102 or any malicious actors. This can ensure proper lifecycle hygiene and maintains security and trust in the wallet ecosystem.

Backing up a user's wallet can be useful for recovering the wallet, such as in connection with a lost or broken user device. A user can begin the process of recovering his or her wallet using a combination of biometrics and email-based recovery information (or other contact information associated with the user's stable key wallet account, which can be stored by the stable key service (e.g., stable key service 150). The stable key service can receive a recovery request (e.g., from a new user device 110) and in connection with the recovery request, can receive biometric data relating to the user and an email address (or other contact information) associated with the user. The stable key service can verify the email address or other contact information and the user's biometric data (e.g., in accordance with the technology disclosed herein) to ensure both are associated with the same user in the stable key service's stored records (e.g., the registration information, the client shard, and/or the server shard).

After successful verification, the server can retrieve the server shard and send it to the user device, as a non-limiting example. The user device (e.g., the user device 110) can reconstruct the stable key using the recovered client shard and live biometrics. This process can restore access to the wallet and its credentials without compromising security.

Alternatively or in addition, user can add one or more additional trusted devices (e.g., a tablet or secondary phone). This can involve securely transferring the necessary wallet components (e.g., BLOBs or derived keys) from the primary user device or server.

Installing Wallet App and Transferring Shards: On the new user device, the wallet application can be installed and can be securely initialized using the shard(s) transferred from the primary user device and newly obtained biometric data for verification. This can ensure that the user can now access his or her wallet from multiple trusted devices, without compromising privacy or control.

Custodian Access Setup: This optional state can enable a user to designate a custodian (e.g., spouse, lawyer) who can recover the wallet under predefined conditions. This can involve the user granting to the custodian certain rights (e.g., rights specific to the custodian) and associated with biometric pairing. That is to say, the custodian and his or her user device (e.g., custodian device) can perform the provisioning (e.g., process 200), credential creation (e.g., process 300), and/or credential authorization (e.g., process 400) processes shown and described herein, and the custodian's credentials can be tied to, or otherwise associated with, the primary user's credentials and/or authorization. Alternatively or in addition, the custodian setup process can involve securely storing fallback access paths (e.g., in case of lost or broken primary user devices or incapacity or death of the primary user). When needed, the custodian can initiate wallet recovery on behalf of the primary user. This can create a temporary or permanent custodial wallet that can provide access under emergency or pre-defined legal circumstances (but always requiring proper authentication and consent, consistent with the technology and processes described herein).

Changing ownership be helpful to accommodate situations of heritage or legacy access (e.g., right of succession) and/or power of attorney. To address such scenarios, the disclosed technology contemplates systems and methods for passing access from the primary user to a another individual, either through legal designation (e.g., inheritance or will) or through a delegated access mechanism (e.g., power of attorney). This often involves pre-authorized setup and cryptographic rekeying to securely transfer control and can operate similarly to the custodian access steps previously described, with the added qualifiers of any related legal triggers (e.g., the primary user passes away).

If a wallet is no longer needed (e.g., due to user intent, end of life, account migration), it can be securely deleted. This process involves revoking access (e.g., by the user, by a legal representative or custodian) and purging stored secrets (e.g., client shards and/or server shards), which can ensure no remnants remain (or at least insufficient remnants to feasibly access a given credential).

In heritage scenarios, once legal or policy-based criteria are satisfied (e.g., as determined by a power of attorney user), a new user (e.g., family member, executor) can gain access to the wallet contents. This can be achieved through a secure, auditable process. For example, the new user can be identified by an ISP-related process. The new user can be pre-registered (e.g., prior to the primary user's passing), as a non-limiting example. Regardless, such processes can help ensure rightful succession and avoiding misuse or unnecessary delay in transfer of wallet contents or assets related thereto.

Upon deletion and/or transfer of a wallet, the initial wallet's lifecycle ends. This final state confirms that all user data has been securely handled, and no unauthorized access (or any access, for that matter) is possible.

### Interactions Between Stable Key Wallet and Other Wallets

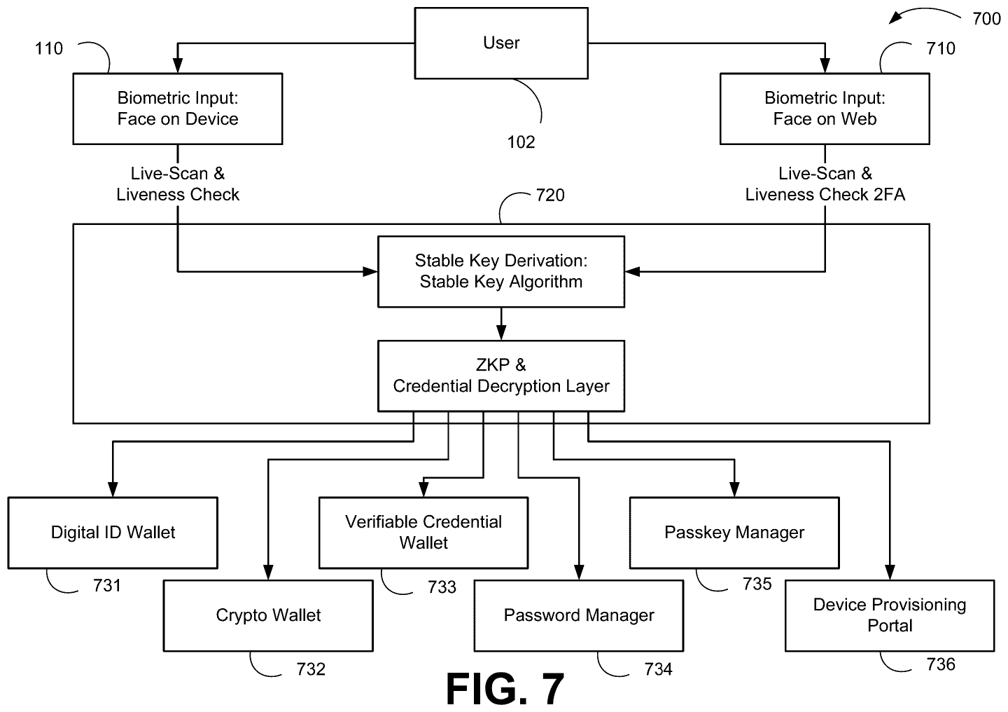

FIG. 7 illustrates a diagram demonstrating a hub and poke architecture (e.g., system 700) in which the stable key wall can function as a biometric trust anchor or a universal authenticator, thereby enabling secure, privacy-preserving access to various other digital wallets and identity tools.

Entry of biometric data relating to the user is contemplated via two avenues. The first has been discussed at length herein and relates to the performing a biometric data capture (e.g., a live facial scan using one or more photos and/or one or more videos) using a trusted user device (e.g., a provisioned and/or registered user device). The biometric data can undergo a liveness detection analysis to help detect or prevent spoofing (e.g., presentation and/or injection attacks).

Another option contemplated herein is the performance of a biometric data capture (e.g., a live facial scan using one or more photos and/or one or more videos) using an online platform 710, which can be useful when a wallet (e.g., a wallet supported by the stable key wallet). The architecture may not be suitable for “cold” wallets. Nevertheless, the stable key algorithm is agnostic.

In the web-based architecture (e.g., using the online platform 710), the user 102 can perform a biometric data capture (e.g., a live facial scan using one or more photos and/or one or more videos) using a computing device (e.g., not necessarily a trusted user device) and/or through a web interface, which can be a potentially less secure option. To help mitigate risk, the web-based method can incorporate multi-factor authentication (e.g., email, text message and/or SMS, an authenticator application), which can help enable trusted presence verification in more flexible or emergency-access scenarios (e.g., device recovery).

Regardless of the method by which the biometric data is captured and transmitted from the user, the system can include a stable key wallet layer (e.g., core security layer), which can include one or more devices configured to perform stable key derivations (e.g., using the stable IT2 algorithm), which can process live biometric input and construct or reconstruct a stable key (e.g., in real-time, in near-real-time). As explained at length herein, no biometric templates are stored. Instead the process is ephemeral and privacy-preserving. The stable key can be used either directly (e.g., strong biometric binding) or to decrypt stored credentials (e.g., weak biometric binding). The ZKP and credential decryption layer (e.g., AuthHub) can comprise logic that can generate or diversify cryptographic keys using the stable key for downstream services. The logic can accept existing cryptographic keys and/or can decrypt previously stored credentials that were previously encrypted using the corresponding key. The logic can thus provide a zero-knowledge proof (ZKP) that is used to prove possession of the key without revealing it. This layer can enable passwordless and identity-verifying interactions across ecosystems. As explained elsewhere, the specific computing devices performing the steps of the stable key wallet layer 720 can be configured and/or arranged according to many different architectures (e.g., architectures (a)-(d) of FIG. 5).

Each outbound edge from the AuthHub can represent a biometric-gated interaction with an external digital asset container, which can include any number of wallets, data vaults, password managers, etc. Some example digital asset containers are shown in FIG. 7. For example, a digital ID wallet 731 (e.g., mDL, eIDAS) can be configured to store government-issued identity documents or eIDs, and the stable key wallet can enable biometric-bound proof of identity and/or can act as a remote assurance that the rightful holder is present before document release.

As another example, a crypto wallet 732 (e.g., Bitcoin™, Ethereum™) can be configured to hold private keys for cryptocurrencies, and the stable key wallet can be configured to either derive deterministic keys from biometric-bound entropy or unlock encrypted wallets using the stable key. This can enable biometric-secured crypto access without dedicated key storage.

As yet another example, a verifiable credential wallet 733 (e.g., W3C VC) can be configured to store academic records, employment proofs, or the like. The stable key wallet can provide present assurance to issuers (e.g., issuers 120) and/or verifiers (e.g., verifiers 130) and/or can ensure the associated credentials are tied to the correct living person.

As yet another example, a passkey manager 734 (e.g., a FIDO2 Passkey Manager) can be configured to manage WebAuthn credentials for passwordless login. The stable key wallet can get the release of cryptographic material necessary for FIDO2 authentication and/or can offer AAL3-level security (Authenticator Assurance Level 3).

As yet another example, a password manager 735 (e.g., Bitwarden™) can be configured to store traditional secrets like passwords or tokens, and the stable key wallet can decrypt the password manager's 735 vault master key, thereby adding biometric-bound multi-factor authentication and preventing unauthorized vault access.

As yet another example, a device provisioning portal 736 can be configured to add new trusted devices to the user's ecosystem, and the stable key wall can help ensure that only the true user can initiate provisioning. Secure backup and recovery workflows can often originate here.

The stable key wallet can thusly serve as the root of trust, allowing seamless and secure access to various digital ecosystems, all gated by a live biometric. And because biometrics are processed on-device and ephemeral, the stable key wallet and related technologies provided herein enhance privacy, while also complying with regulations like GDPR (Regulation (EU) 2016/679 (General Data Protection Regulation)). Leveraging zero knowledge proofs, the disclosed technology enables users to prove possession of secrets without exposing them, which is ideal for remote and high-assurance scenarios. Moreover, the disclosed technology supports multiple wallet types, as discussed in more detail below, providing a centralized source of security and privacy across numerous platforms (e.g., third party platforms).

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable nonvolatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions (e.g., associated data structures and/or schemas) and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A method comprising:
receiving a certificate signing request from a user device associated with a user;
receiving, from the user device, biometric data associated with the user;
creating a stable key based at least in part on the biometric data;
creating a private key based at least in part on the stable key;
transmitting the private key to the user device for local storage thereon;
creating a public key based at least in part on the private key; and
forwarding the certificate signing request to an issuer.

2. The method of claim 1, further comprising receiving additional user-related data.

3. The method of claim 2, wherein the additional user-related data comprises data indicative of an identification document associated with the user.

4. The method of claim 3, wherein the issuer is an identity service provider.

5. The method of claim 4, wherein creating the private key comprises:
creating a derived key based at least in part on the stable key; and
creating the private key based at least in part on the derived key.

6. The method of claim 1, wherein the issuer is an attribute service provider.

7. The method of claim 6, further comprising receiving additional user-related data comprising an age-indicating image of the user.

8. A system comprising:
one or more processors; and
memory having instructions stored thereon that, when executed by the one or more processors, cause the system to:
receive a certificate signing request from a user device associated with a user;
receive, from the user device, biometric data associated with the user;
create a stable key based at least in part on the biometric data;
create a private key based at least in part on the stable key;
transmit the private key to the user device for local storage thereon;
create a public key based at least in part on the private key; and
forward the certificate signing request to an issuer.

9. The system of claim 8, wherein the instructions, when executed by the one or more processors, further cause the system to receive additional user-related data.

10. The system of claim 9, wherein the additional user-related data comprises data indicative of an identification document associated with the user.

11. The system of claim 10, wherein the issuer is an identity service provider.

12. The system of claim 11, wherein creating the private key comprises:
creating a derived key based at least in part on the stable key; and
creating the private key based at least in part on the derived key.

13. The system of claim 8, wherein the issuer is an attribute service provider.

14. The system of claim 13, wherein the instructions, when executed by the one or more processors, further cause the system to receive additional user-related data comprising an age-indicating image of the user.

15. A non-transitory, computer-readable medium having instructions stored thereon that, when executed by one or more processors of a system, cause the system to:
receive a certificate signing request from a user device associated with a user;
receive, from the user device, biometric data associated with the user;
create a stable key based at least in part on the biometric data;
create a private key based at least in part on the stable key;
transmit the private key to the user device for local storage thereon;
create a public key based at least in part on the private key; and
forward the certificate signing request to an issuer.

16. The non-transitory, computer-readable medium of claim 15, wherein the instructions, when executed by the one or more processors, further cause the system to receive additional user-related data.

17. The non-transitory, computer-readable medium of claim 16, wherein the additional user-related data comprises data indicative of an identification document.

18. The method of claim 3, wherein the issuer is an identity service provider.

19. The non-transitory, computer-readable medium of claim 17, wherein creating the private key comprises:
creating a derived key based at least in part on the stable key; and
creating the private key based at least in part on the derived key.

20. The non-transitory, computer-readable medium of claim 15, wherein:
the issuer is an attribute service provider; and
the instructions, when executed by the one or more processors, further cause the system to receive additional user-related data comprising an age-indicating image of the user.
